(19) United States
(12) Patent Application Publication
(10) Pub. No.: US 2020/0175121 A1
(43) Pub. Date: Jun. 4, 2020

(54) SYSTEM AND METHOD FOR PREDICTING ANALYTICAL ABNORMALITY IN COMPUTATIONAL FLUID DYNAMICS ANALYSIS

(71) Applicant: DOOSAN HEAVY INDUSTRIES & CONSTRUCTION CO., LTD., Changwon-si (KR)

(72) Inventors: Jae Hyeon PARK, Hwaseong-si, (KR); Sang Jin LEE, Yongin-si, (KR); Hyun Sik KIM, Gimpo-si, (KR); Jee Hun PARK, Gwangmyeong-si, (KR)

(21) Appl. No.: 16/566,967

(22) Filed: Sep. 11, 2019

(30) Foreign Application Priority Data
Nov. 30, 2018 (KR) 10-2018-0152749

(51) Int. Cl. G06F 17/50

(52) U.S. Cl. CPC G06F 17/50; G06F 2217/16

(57) ABSTRACT

A system and method for predicting an analytical abnormality are provided. The method for predicting an analytical abnormality may include generating a signal generation model and an analysis model for a design object based on first analysis data, applying a signal generated by the signal generation model to the analysis model based on second analysis data to calculate one or more estimated values, comparing the estimated values and the second analysis data to generate a plurality of early warning information, and determining whether to output an early warning based on whether the plurality of early warning information satisfy a preset condition.

### CROSS REFERENCE TO RELATED APPLICATION

This application claims priority to Korean Patent Application No. 10-2018-0152749, filed on Nov. 30, 2018, the entire disclosure of which is incorporated herein by reference in its entirety.

### BACKGROUND

### 1. Field

Apparatuses and methods consistent with exemplary embodiments relate to a system and method for predicting analytical abnormality in a process of using a computer to analyze physical states of components or other configurations installed in a plant when the components or configurations are designed, by determining whether the analysis is performed correctly before an analyzed result is calculated.

### 2. Description of the Related Art

There are many different types of installations in a plant which need to be designed before they are built in, thus taking much time and effort. In order to produce high-performance and high-reliability key components, computer-based analysis, such as fluid analysis, structural analysis, electromagnetic analysis, or the like, is necessary in designing the components. Analytical interpretation is made over several tens to hundreds of iterations, and one interpretation takes quite a bit of time.

Meanwhile, during the repeated analysis, many problems may arise. Accordingly, result values that are not required for the design are often generated. For example, if a designer enters incorrect grid design data, operating condition settings, primary parameter settings, etc. for the analysis, the result of analytical interpretation performed with much time and effort may become completely incorrect, or the computer-assisted analysis itself may be interrupted. If such an incorrect analytical interpretation is obtained or the computer-assisted analysis is interrupted, reanalysis should be newly performed from the beginning. Waste of time and effort due to reanalysis may cause huge damages in the process of constructing a plant and installations thereof.

To solve the problems in the design of a plant or installations thereof, it is needed a system for predicting analytical abnormality in the design, thereby minimizing the waste of time and effort taken in the design.

### SUMMARY

Aspects of one or more exemplary embodiments provide a system which can continuously evaluate whether a physical analysis required for the design of a plant or installations thereof is performed correctly to recognize analytical abnormality in the design, thereby avoiding waste of time and resources taken in the analysis of the design.

Aspects of one or more exemplary embodiments provide a system which can increase the efficiency of the entire design of a plant or installations thereof by reducing the waste of time and resources taken in the analysis of the design.

Additional aspects will be set forth in part in the description which follows and, in part, will become apparent from the description, or may be learned by practice of the exemplary embodiments.

According to an aspect of an exemplary embodiment, there is provided a method of predicting an analytical abnormality, the method including: generating a signal generation model and an analysis model for a design object based on first analysis data; applying a signal generated by the signal generation model to the analysis model based on second analysis data to calculate one or more estimated values; comparing the estimated values and the second analysis data to generate a plurality of early warning information; and determining whether to output an early warning based on whether the plurality of early warning information satisfy a preset condition.

The first analysis data and the second analysis data may be obtained from a result of a computational fluid dynamics analysis performed on the design object.

The first analysis data may be obtained before the second analysis data is obtained.

The first analysis data and the second analysis data may include data for cells for a fluid around the design object, the cells being obtained by dividing surroundings of the design object for each unit space.

The applying the signal may include: generating a new signal based on the second analysis data; and applying the new signal to the analysis model to calculate an estimated value.

The method may further include performing a compensation process on the new signal after the applying the new signal to the analysis model, the new signal applied to the analysis model being a compensated signal.

The comparing the estimated values and the second analysis data may include: calculating a residual value between the estimated value and the second analysis data; and generating early warning information based on the residual value.

The early warning information may include information about whether the residual value is within a preset range.

The early warning information may be generated for each cell.

The determining whether to output the early warning may include at least one of determining the analytical abnormality for each individual cell, dividing the cells into groups, each group having at least two cells, and determining the analytical abnormality for each group, and determining the analytical abnormality for all cells.

According to an aspect of another exemplary embodiment, there is provided a system for predicting an analytical abnormality, the system including: a modeling layer configured to generate a signal generation model and an analysis model for a design object based on first analysis data; and a prediction layer configured to calculate one or more estimated values using the signal generation model and the analysis model based on second analysis data, and compare the estimated values and the second analysis data to determine whether an abnormality occurs in the analysis for the design object.

The first analysis data and the second analysis data may be obtained from a result of a computational fluid dynamics analysis performed on the design object.

The first analysis data and the second analysis data may include data for cells for a fluid around the design object, the cells being obtained by dividing surroundings of the design object for each unit space.

The prediction layer may include: a prediction unit configured to calculate one or more estimated values using the signal generation model and the analysis model based on the second analysis data; an early warning logic unit configured to generate early warning information based on the estimated values; and a diagnosis unit configured to determine whether an abnormality occurs in the analysis for the design object based on the early warning information.

The prediction unit may include: a signal generator configured to generate a new signal based on the second analysis data; and a simulator configured to apply the new signal to the analysis model generated by the modeling layer to calculate an estimated value.

The system may further include a compensator configured to perform a compensation process on the new signal generated by the signal generator, and transmit the compensated signal to the simulator.

The early warning logic unit may include: a residual value calculator configured to calculate a residual value between the estimated value and the second analysis data; and an early warning information generator configured to generate early warning information based on the residual value.

The early warning information may include information about whether the residual value is within a preset range.

The diagnosis unit may determine the analytical abnormality for each individual cell, for each cell group having at least two cells, or for all cells.

According to an aspect of another exemplary embodiment, there is provided a non-transitory computer-readable storage medium storing instructions of executing a method of predicting an analytical abnormality, the method including: generating a signal generation model and an analysis model for a design object based on first analysis data; applying a signal generated by the signal generation model to the analysis model based on second analysis data to calculate one or more estimated values; comparing the estimated values and the second analysis data to generate a plurality of early warning information; and determining whether to output an early warning based on whether the plurality of early warning information satisfy a preset condition.

According to one or more exemplary embodiments, it is possible to drastically reduce computational analysis time taken in the design of a plant or installations thereof, thereby reducing the time taken in the design of the entire plant and greatly reducing the construction cost of the plant.

In addition, according to one or more exemplary embodiments, it is ensured that even a non-skilled person can easily perform an analysis operation, thereby having an effect of cutting down personal expenses or utilizing personnel more flexibly from the viewpoint of an employer.

### BRIEF DESCRIPTION OF THE DRAWINGS

The above and other aspects will be more apparent from the following description of the exemplary embodiments with reference to the accompanying drawings, in which:

FIG. 1 is a schematic diagram illustrating an example of computational fluid dynamics in a design of a turbine blade in a plant;

FIG. 2 is a block diagram illustrating a structure of a system according to an exemplary embodiment;

FIG. 3 is a block diagram illustrating a configuration of a prediction unit of the system according to an exemplary embodiment;

FIG. 4 is a block diagram illustrating a configuration of an early warning logic unit of the system according to an exemplary embodiment; and

FIG. 5 illustrates a configuration of a diagnosis unit of the system according to an exemplary embodiment.

### DETAILED DESCRIPTION

Various modifications may be made to the embodiments of the disclosure, and there may be various types of embodiments. Thus, specific embodiments will be illustrated in drawings, and embodiments will be described in detail in the description. However, it should be noted that the various embodiments are not for limiting the scope of the disclosure to a specific embodiment, but they should be interpreted to include all modifications, equivalents or alternatives of the embodiments included in the ideas and the technical scopes disclosed herein. Meanwhile, in case it is determined that in describing the embodiments, detailed explanation of related known technologies may unnecessarily confuse the gist of the disclosure, the detailed explanation will be omitted.

Unless otherwise defined, the terms including technical and scientific terms used herein have the same meaning as would be generally understood by those skilled in the relevant art. However, these terms may vary depending on the intentions of the person skilled in the art, legal or technical interpretation, and the emergence of new technologies. In addition, some terms are arbitrarily selected by the applicant. These terms may be construed per the meaning defined or described herein and, unless otherwise specified, may be construed on the basis of the entire contents of this specification and common technical knowledge in the art.

The functional blocks illustrated in the drawings and described below are only examples of possible implementations. Other functional blocks may be used in other implementations without departing from the spirit and scope of the detailed description. Also, while one or more functional blocks of the present disclosure are represented by separate blocks, one or more of the functional blocks may be a combination of various hardware and software configurations that perform the same function.

Also, “a module” or “a part” in the disclosure perform at least one function or operation, and these elements may be implemented as hardware or software, or as a combination of hardware and software. Further, a plurality of “modules” or “parts” may be integrated into at least one module and implemented as at least one processor, except “modules” or “parts” that need to be implemented as specific hardware.

The terminology used herein is for the purpose of describing particular embodiments only and is not intended to limit the scope of the disclosure. As used herein, the singular forms “a”, “an”, and “the” are intended to include the plural forms as well unless the context clearly indicates otherwise. Further, the terms “comprises”, “includes”, or “have/has” should be construed as designating that there are such features, regions, integers, steps, operations, elements, components, and/or a combination thereof in the specification, not to exclude the presence or possibility of adding one or more of other features, regions, integers, steps, operations, elements, components and/or combinations thereof.

In addition, terms concerning attachments, coupling and the like, such as “connected” and “coupled” refer to a relationship in which structures are secured or attached to one another either directly or indirectly through intervening structures.

Further, terms such as “first,” “second,” and so on may be used to describe a variety of elements, but the elements should not be limited by these terms. The terms are used simply to distinguish one element from other elements. The use of such ordinal numbers should not be construed as limiting the meaning of the term. For example, the components associated with such an ordinal number should not be limited in the order of use, placement order, or the like. If necessary, each ordinal number may be used interchangeably.

Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

Hereinafter, exemplary embodiments will be described in detail with reference to the accompanying drawings.

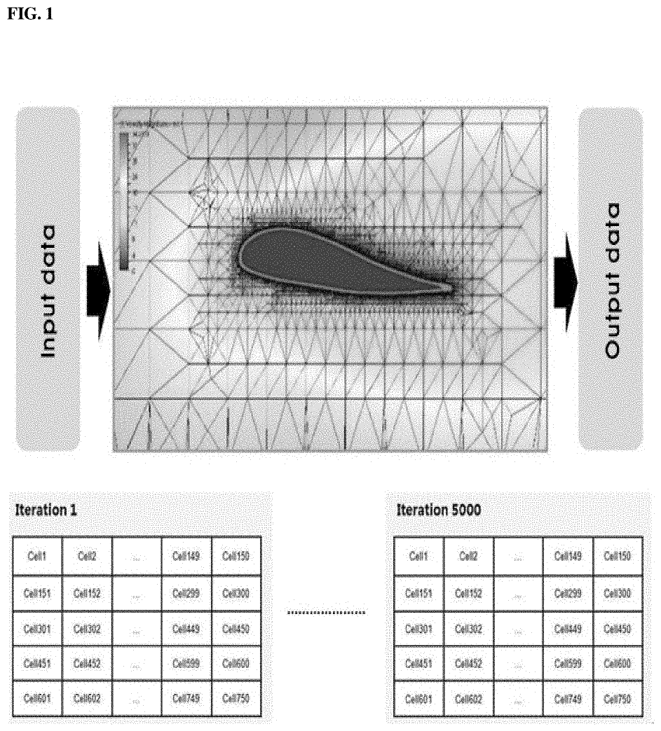

An example of computational fluid dynamics (CFD) analysis, i.e., fluid dynamics analysis performed by a computer will be described with reference to FIG. 1.

FIG. 1 illustrates a computer design process for a blade of a turbine installed in a plant, and more specifically, illustrates a process of computer-simulating a flow of fluid flowing around a virtually designed blade. This simulation is iterated hundreds to thousands of times to calculate data for each iteration, thereby allowing designers to determine the most suitable blade structure from the repeated simulation analysis.

Referring to FIG. 1, a plurality of triangle parts are indicated around the virtual blade, and each triangle part will be referred to as a cell. The cell means a unit for dividing and analyzing the fluid around the blade by space, and each cell may include a plurality of hydrodynamic data. In FIG. 1, a total of 750 cells are divided and disposed around the blade, and each cell may include 68 state values.

Assuming that the simulation for the blade is repeated 5000 times, a total of 750 cells are simulated so that 68 state values included in each cell may be calculated as output data for the simulation for each iteration.

It is understood that the definition of the cell may not be limited to the example illustrated in FIG. 1, and may be changed or vary according to one or more other exemplary embodiments.

When designing a component such as a blade in a turbine, the most time-consuming and resource-intensive part is an analysis process as shown in FIG. 1. In particular, fluid dynamics analyses take more time than structural analyses, and among the fluid analyses, 3D analysis takes a great deal of time. For example, post-design simulation or analysis for a component is repeatedly performed 70 to 80 times by an analysis expert using a computer on a blade in a turbine. Considering that several hours are taken to perform an analysis operation once, and that the higher the number of iterations of a simulation or analysis is, the better a component can be completely designed, it will be easily appreciated that construction time and cost for entire turbine and plant as well as a blade are saved by reducing the time for simulation or analysis.

One or more exemplary embodiments provide a system and method for determining whether simulation and analysis processes are performed correctly by creating an arbitrary analysis model from previously obtained analysis data during the repeated simulation and analysis processes and determining whether a value output when a currently obtained analysis data is input deviates from a prediction range according to the created analysis model.

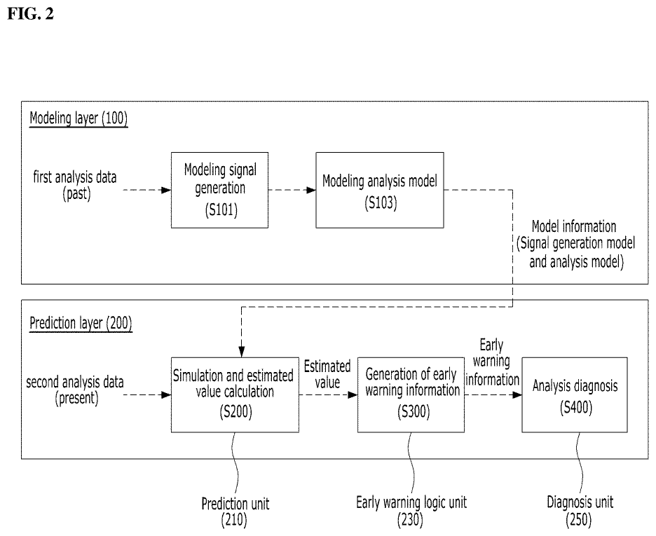

FIG. 2 is a block diagram illustrating a structure of an analytical abnormality prediction system according to an exemplary embodiment. The system may include two layers including a modeling layer 100 and a prediction layer 200.

Although the analytical abnormality prediction system includes configuration blocks designated by functions or steps to be performed, it will be appreciated that the system may be implemented as a device, including a CPU for operation and a memory that can store program and data for operation, and that the layers and configurations of the system may be implemented on a program designed in a computer-readable language, and executed by the CPU. Further, the analytical abnormality prediction system may be implemented by hardware or firmware, software, or a combination thereof. When implemented using hardware, the system may include an application specific integrated circuit (ASIC), or a digital signal processor (DSP), a digital signal processing device (DSPD), a programmable logic device (PLD), a field programmable gate array (FPGA), and the like. When implemented using firmware or software, the system may include a module, procedure, or function that performs the above functions or operations.

Referring to FIG. 2, the modeling layer 100 is configured to generate a model for a signal-generation unit (hereinafter, referred to as a signal generation model) and an analysis model on the basis of previously collected analysis data. That is, the modeling layer 100 generates the signal generation model and the analysis model. Here, it is understood that the order in which respective models are generated may be changed or two models may be generated at the same time.

In operation S101 of generating the signal generation model, the modeling layer 100 collects pre-collected first analysis data and generates a model that simulates the signal generation unit, that is, a signal generation model. The signal generation unit refers to a configuration capable of arbitrarily generating analysis data calculated as a result of simulation for a design object. In the exemplary embodiment, the signal generation unit for arbitrarily generating the analysis data is generated through modeling, so that input data used in the analysis model can be generated. For example, the signal generation model serves to generate the output data of the simulation described in FIG. 1, for example, any of 68 state values included in each cell. In this case, the first analysis data refers to analysis data previously collected in connection with an object to be designed. For example, if the object of design is a blade of a turbine in a plant, the first analysis data may include analytical data obtained for previous iterations such as a viscosity of a laminar flow, a viscosity of a turbulence, a density, a momentum of fluid in the X, Y, and Z directions for each cell, and internal energy of fluid flowing around the blade.

After the signal generation model is modeled (operation S101), the modeling layer 100 models an analysis model (operation S103). The analysis model simulates physical properties of an object, and means a mathematical equation. While the analysis model may be a computational fluid dynamics (CFD) model, it is not limited thereto.

The signal generation model and the analysis model generated by the modeling layer 100 are transferred to a prediction unit 210 in the prediction layer 200.

The prediction layer 200 of the analytical abnormality prediction system may include a prediction unit 210, an early warning logic unit 230, and a diagnosis unit 250. Based on the signal generation model and the analysis model generated by the modeling layer 100, the prediction layer 200 inputs current analysis data to the analysis model to calculate a result value, i.e., an estimated value, (operation S200), performs an early warning logic to determine whether the current analysis is performed correctly on the basis of the estimated value to generate early warning information (operation S300), and diagnoses the analysis on the basis of the generated early warning information (operation S400).

The prediction unit 210 of the prediction layer 200 is configured to receive information on the signal generation model and the analysis model generated in the modeling layer 100, and perform a simulation by the signal generation model while applying collected second analysis data to the analysis model to calculate result values, i.e. estimated values. Here, the second analysis data is distinguished from the first analysis data. While the first analysis data is analysis data obtained from simulation and analysis on an existing design object, the second analysis data refers to currently collected analysis data, i.e., most recent analysis data updated. For example, if a blade in a turbine is an object to be designed, and the analysis data obtained in the previous round of simulation and analysis iteration is the first analysis data, the analysis data in the currently ongoing iteration may be the second analysis data. However, this is merely for illustrative purposes and it is not limited thereto. In addition, the term of iteration may mean that when performing analysis operation, the analysis operation may be repeatedly performed.

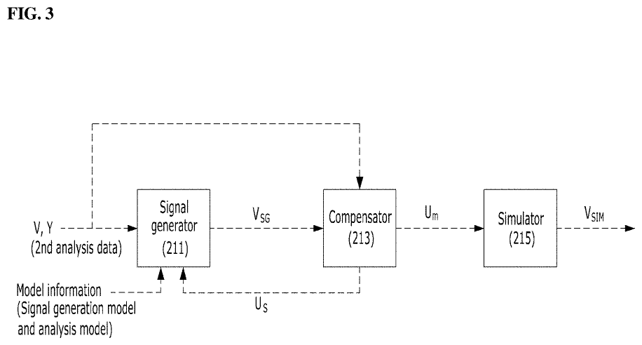

FIG. 3 is a configuration of the prediction unit 210 of the system according to an exemplary embodiment. The prediction unit 210 may include a signal generator 211, a compensator 213, and a simulator 215.

In the signal generation unit 211, the signal generation model generated by the modeling layer 100 generates a signal which may be arbitrary analysis data about a design object. Referring to FIG. 3, the signal generator 211 receives the second analysis data V and Y, generates a new signal V_{SG} based on the received data V and Y, and transfers the signal V_{SG} to the compensator 213. The second analysis data V and Y may include data obtained from the cell. For example, V may include a plurality of data in a matrix pattern, such as a viscosity of a laminar flow, a viscosity of a turbulent, and the like. Y may include a plurality of data in a matrix pattern, such as a density, a momentum in the X/Y/Z directions, and an internal energy. V_{SG} may be new analysis data including only data necessary for predicting analytical abnormality among a plurality of data included in V. In other words, the signal generator 211 may arbitrarily generate the analysis data required to calculate a prediction value.

The compensator 213 may increase an accuracy of the estimated value calculated by the prediction unit 210, and receive V_{SG} as a compensation object. The compensator 213 may also receive the second analysis data V and Y to compensate the V_{SG} signal with reference to the second analysis data. The compensator 213 may output Um which is transmitted to the simulator 215 and Us which is transmitted to the signal generator 211. Um is a signal after V_{SG} is compensated by the compensator 213, and the signal is an optimum signal compensated to more accurately calculate V_{SIM}, which is an estimated value to be calculated by the simulator 215. Us is an optimum signal for generating V_{SG}, generated by the signal generation unit 211, more accurately, and is used as feedback data for generating a subsequent V_{SG} signal after transmitted to the signal generator 211.

The compensator 213 may compensate for an input signal so that analysis data necessary for a simulation for predicting an analytical abnormality has a more appropriate value. That is, the compensator 213 compensates for a calculated value by adding a value or an estimated value according to the analysis result of each iteration or the previous iteration, that is, by using a difference between analysis values or estimated values corresponding to the current iteration k and the previous iteration k−1, thereby accurately predicting a value. The compensation may be performed by multiplying a difference value between the current iteration k and the previous iteration k−1 by a weighted value to determine a value to be compensated.

Referring again to FIG. 2, the early warning logic unit 230 may receive the result value (i.e., the estimated value) calculated by the prediction unit 210, and compare the estimated value with previously stored analysis data to generate early warning information, i.e., basic information for recognizing analytical abnormality for design objects.

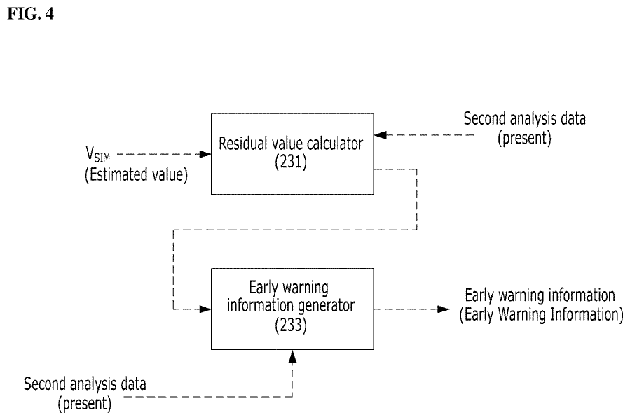

FIG. 4 is a block diagram illustrating a configuration of the early warning logic unit 230 according to an exemplary embodiment. Referring to FIG. 4, the early warning logic unit 230 may include a residual value calculator 231 and an early warning information generator 233.

The residual value calculator 231 may receive estimated value V_{SIM} calculated by the prediction unit 210 and the second analysis data, calculate a difference between the estimated value and the second analysis data, i.e., a residual value, and transmit the calculated residual value to the early warning information generator 233.

The early warning information generator 233 may determine whether the residual value satisfies a preset condition or range to generate a single early warning information or multiple information about the corresponding analysis, and provide the information to a diagnosis unit 250 of the prediction layer 200. In this case, the early warning information generator 233 may generate early warning information for each variable in each cell, and the generated early warning information may be used by the diagnosis unit 250 to determine analytical abnormality in the future.

That is, the early warning information generator 233 generates only the early warning information, not an actual early warning, and delivers the early warning information to the diagnosis unit 250.

The diagnosis unit 250 may receive early warning information generated by the early warning logic unit 230 to determine whether there is an abnormality in the corresponding analysis model based on the early warning information, and generate early warning.

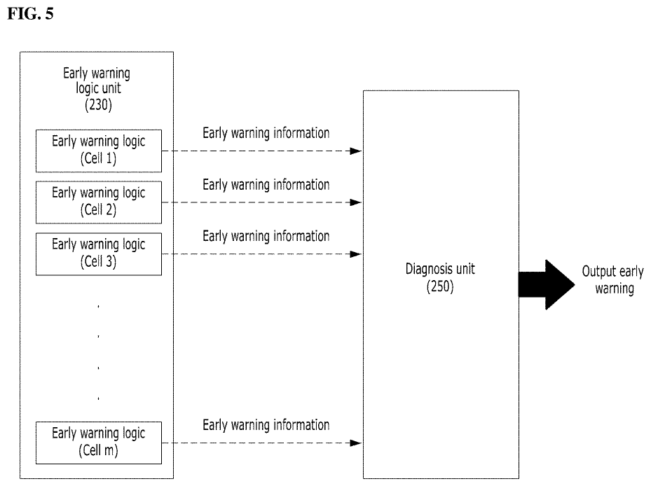

FIG. 5 is a diagram illustrating a function of the diagnosis unit 250 according to an exemplary embodiment. The diagnosis unit 250 may receive multiple early warning information for each cell from the early warning logic unit 230, and generate an early warning in response to determining that the preset condition is satisfied based on all of the information.

For example, assuming that a total of ten early warning information are received from a first cell to a tenth cell, the diagnosis unit 250 may generate an early warning indicating that an abnormality has occurred in the currently performed analysis for the design object based on the early warning information, if three of ten information are out of the preset condition or range. The generating the early warning may be outputting the early warning to a display and outputting sound to recognize the warning.

The diagnosis unit 250 may determine whether an abnormality occurs for individual cells, group at least two or more cells and determine whether an abnormality exists for each group, and as a result, determine whether an abnormality occurs for all cells. Accordingly, the diagnosis unit 250 may determine whether an analytical abnormality occurs step by step. However, it is understood that this is merely an example, and may be changed or vary according to one or more other exemplary embodiments. For example, the determination of the analytical abnormality may be performed for the grouped cells and all cells, without the determination of the analytical abnormality for individual cells, or otherwise, directly after the determination of the analytical abnormality for the individual cells, the determination of the analytical abnormality may be performed for all cells.

While exemplary embodiments have been described with reference to the accompanying drawings, it will be apparent to those skilled in the art that various modifications in form and details may be made therein without departing from the spirit and scope as defined in the appended claims. Therefore, the description of the exemplary embodiments should be construed in a descriptive sense and not to limit the scope of the claims, and many alternatives, modifications, and variations will be apparent to those skilled in the art.

What is claimed is:

1. A method of predicting an analytical abnormality, the method comprising:
generating a signal generation model and an analysis model for a design object based on first analysis data;
applying a signal generated by the signal generation model to the analysis model based on second analysis data to calculate one or more estimated values;
comparing the estimated values and the second analysis data to generate a plurality of early warning information; and
determining whether to output an early warning based on whether the plurality of early warning information satisfy a preset condition.

2. The method according to claim 1, wherein the first analysis data and the second analysis data are obtained from a result of a computational fluid dynamics analysis performed on the design object.

3. The method according to claim 2, wherein the first analysis data is obtained before the second analysis data is obtained.

4. The method according to claim 3, wherein the first analysis data and the second analysis data include data for cells for a fluid around the design object, the cells being obtained by dividing surroundings of the design object for each unit space.

5. The method according to claim 4, wherein the applying the signal comprises:
generating a new signal based on the second analysis data; and
applying the new signal to the analysis model to calculate an estimated value.

6. The method according to claim 5, further comprising performing a compensation process on the new signal after applying the new signal to the analysis model, the new signal applied to the analysis model being a compensated signal.

7. The method according to claim 4, wherein the comparing the estimated values and the second analysis data comprises:
calculating a residual value between the estimated value and the second analysis data; and
generating early warning information based on the residual value.

8. The method according to claim 7, wherein the early warning information includes information about whether the residual value is within a preset range.

9. The method according to claim 6, wherein the early warning information is generated for each cell.

10. The method according to claim 4, wherein the determining whether to output the early warning comprises at least one of determining the analytical abnormality for each individual cell, dividing the cells into groups, each groups having at least two cells, and determining the analytical abnormality for each group, and determining the analytical abnormality for all cells.

11. A system for predicting an analytical abnormality, the system comprising:
a modeling layer configured to generate a signal generation model and an analysis model for a design object based on first analysis data; and
a prediction layer configured to calculate one or more estimated values using the signal generation model and the analysis model based on second analysis data, and compare the estimated values and the second analysis data to determine whether an abnormality occurs in the analysis for the design object.

12. The system according to claim 11, wherein the first analysis data and the second analysis data are obtained from a result of a computational fluid dynamics analysis performed on the design object.

13. The system according to claim 12, wherein the first analysis data and the second analysis data include data for cells for a fluid around the design object, the cells being obtained by dividing surroundings of the design object for each unit space.

14. The system according to claim 13, wherein the prediction layer comprises:
a prediction unit configured to calculate one or more estimated values using the signal generation model and the analysis model based on second analysis data;
an early warning logic unit configured to generate early warning information based on the estimated values; and
a diagnosis unit configured to determine whether an abnormality occurs in the analysis for the design object based on the early warning information.

15. The system according to claim 14, wherein the prediction unit comprises:
a signal generator configured to generate a new signal based on the second analysis data; and
a simulator configured to apply the new signal to the analysis model generated by the modeling layer to calculate an estimated value.

16. The system according to claim 15, further comprising a compensator configured to perform a compensation process on the new signal generated by the signal generator, and transmit the compensated signal to the simulator.

17. The system according to claim 14, wherein the early warning logic unit comprises:
a residual value calculator configured to calculate a residual value between the estimated value and the second analysis data; and
an early warning information generator configured to generate early warning information based on the residual value.

18. The system according to claim 17, wherein the early warning information includes information about whether the residual value is within a preset range.

19. The system according to claim 14, wherein the diagnosis unit is configured to determine the analytical abnormality for each individual cell, for each cell group having at least two cells, or for all cells.

20. A non-transitory computer-readable storage medium storing instructions of executing a method of predicting an analytical abnormality, the method comprising:
generating a signal generation model and an analysis model for a design object based on first analysis data;
applying a signal generated by the signal generation model to the analysis model based on second analysis data to calculate one or more estimated values;
comparing the estimated values and the second analysis data to generate a plurality of early warning information; and
determining whether to output an early warning based on whether the plurality of early warning information satisfy a preset condition.
